(19) United States
(12) Patent Application Publication
(10) Pub. No.: US 2006/0044950 A1
(43) Pub. Date: Mar. 2, 2006

(54) Data display method for digital storage devices

(75) Inventor: Chung-Chih Tung, Taipei (TW)

Correspondence Address: Welsh & Katz, Ltd.;Eric D. Cohen, 22nd Floor, 120 South Riverside Plaza, Chicago, IL, 60606, US

(73) Assignee: Mitac Technology Corp., Hsin-Chu Hsien (TW)

(21) Appl. No.: 10/926,248

(22) Filed: Aug. 25, 2004

(51) Int. Cl. G11B 21/08

(52) U.S. Cl. 369/30.01

(57) ABSTRACT

A data display method for digital storage devices implemented on a computer executable platform. The invention reads data through a dynamic setting of a Basic Input/Output System and a card read controller, and selectively displays the data on a display device without entering the operating system. This greatly improves the convenience of using digital storage devices.

### FIELD OF THE INVENTION

The invention relates to a data display method for digital storage devices, and particularly to a method that displays stored data without entering the operating system.

### BACKGROUND OF THE INVENTION

The rapid advance of technology has spawned many hi-tech products that have enriched people's lives. Traditional products that face such an influence can quickly become obsolete. Hi-tech products are no longer luxury goods affordable only for a privileged few. Their powerful functions, portable convenience and low prices have gradually been accepted by many users, and have benefited their lives.

For instance, the conventional camera or V8 video camera mainly aims to take picture records of family life in the house or during outdoor activities. These days, with the progress of technology and wide use of computers, picture records have been gradually taken over by digital camera (DC) and digital video camera (DC Cam) technology, and have been transferred to the computer platform for storing and processing. In order to achieve even higher picture quality and greater capacity, DVD Cam that uses DVD RAM (Digital Versatile Disc Random Access Memory) as the storage medium also has been developed and is now available on the market.

Those digital storage devices must be portable and easy to carry, hence generally cannot be continuously used for a prolonged period of time. Some of the pictures also have to be patched and edited on the computer. This process generally involves: 1. Developing photos; 2. entering the computer for viewing; 3. recording the data on optical discs, and; 4. displaying the data with a common VCD (Video Compact Disc) or DVD (Digital Video Disc) player.

Because not every piece of data is necessarily desired, developing all of them and sifting them through individually is costly. Moreover, seeing the data on the computer requires a number of lengthy machine start procedures. The ability to record data on optical discs and see the data with the player is restricted by the playing environment, and the procedures are tedious.

### SUMMARY OF THE INVENTION

In view of the aforesaid disadvantages, the primary object of the invention is to provide a data display method for digital storage devices that can selectively enter a data display mode during the computer Power On Self Test (POST) process to display data stored in the digital storage devices on a display device, and can be dynamically controlled with an input device such as a remote control device, keyboard or mouse.

The data display method for digital storage devices according to the invention mainly includes the following procedures: start a Basic Input/Output System (BIOS); initialize the system; proceed display mode initialization; establish data access mode of a digital storage device; finally, read and display data.

According the method of the invention, users do not have to go through the procedures of developing photos, recording on the optical disc or entering the computer to see the data. Instead, users can start the computer and enter the data display mode, and the content of the data in the storage device may be displayed dynamically. Not only is the cost reduced, but data may also be seen through a simple operation procedure. The product thus designed is more convenient to use and can better meet users' requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the system architecture of the data display method for digital storage devices of the invention.

FIG. 2 is the process flow chart of the data display method for digital storage devices of the invention.

### DESCRIPTION OF THE PREFERRED EMBODIMENTS

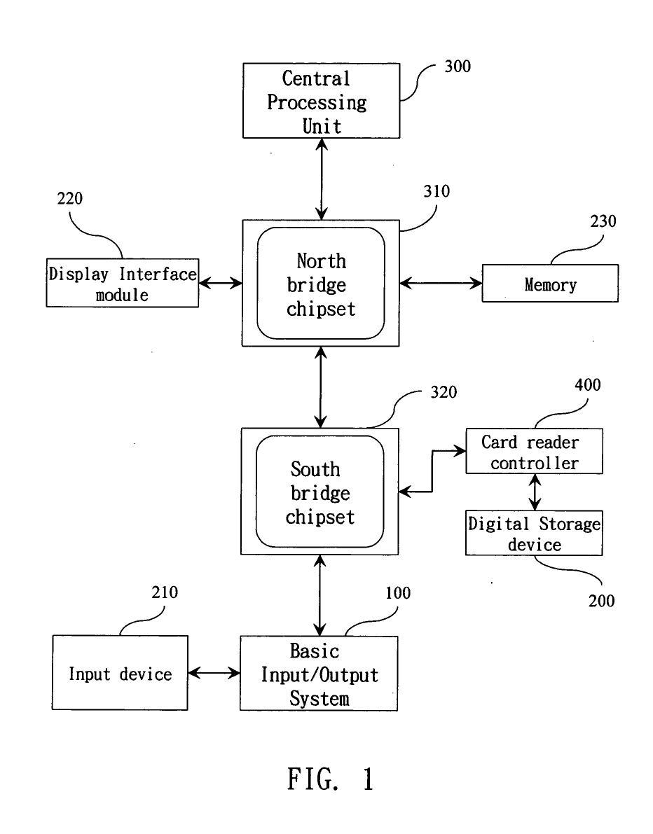

Refer to FIG. 1 for the system architecture of the method of the invention. First, connect a digital storage device to a computer host for processing. The system mainly includes the following elements:
1. A Basic Input/Output System 100 to store and provide required machine start information.
2. A South Bridge chipset 320 to control and coordinate the digital storage device 200 and an input device 210 (such as the basic external input device—keyboard, mouse, etc.).
3. A North Bridge chipset 310 for setting and linking a display module 220 and controlling a memory 230.
4. A central processing unit (CPU) 300 to execute processing and data handling operations after having received information from other elements.
5. A card reader controller 400 linking to the digital storage device 200 to access data stored therein.

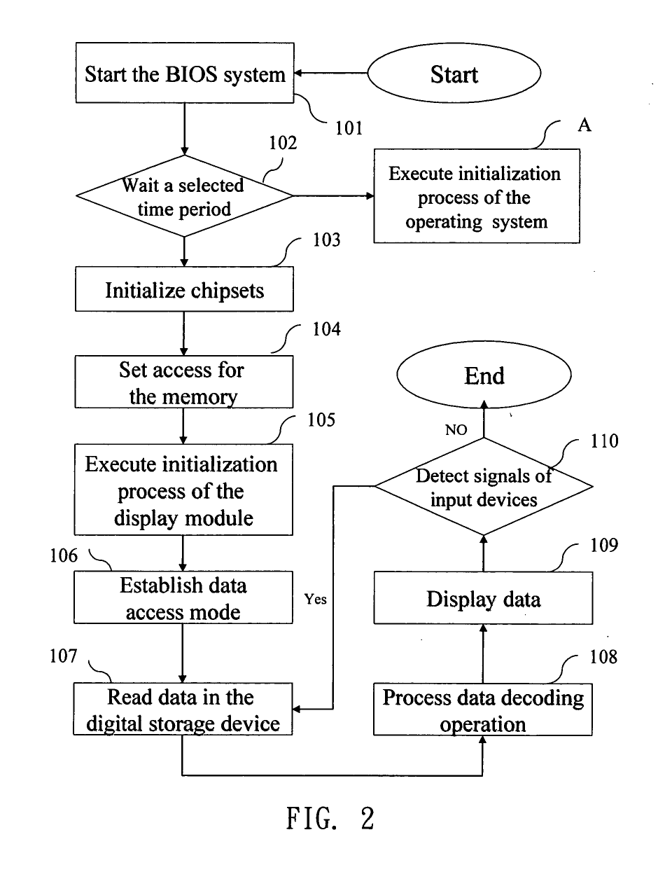

Refer to FIG. 2 for the process flow of the invention. It includes the following procedures: first, start the Basic Input/Output System (step 101); next, wait for a preset period of time to receive signals from the input device (step 102); the signals of the input device are generated by depressing one or more keys to process the following operations: controlling data display conditions and executing initialization operations of the operating system; if it is detected that the digital storage device 200 is not connected, execute the initialization operation of the operating system (step A); if connected, proceed with chipset initialization operation according to the setting of the Basic Input/Output System (step 103); process setting of the memory (step 104); execute display mode initialization operation for the display interface module 200 (step 105); establish data access mode (step 106); read the data in the digital storage device through the card reader controller 400 (step 107); execute data decoding and processing through the central processing unit 300 and the memory 320 (step 108); display data through the display interface module 220 (step 109); finally, detect for input device signals (step 110); if detected, return to step 106 to display other data; if not detected, end the process.

Through the method of the invention set forth above, users do not have to develop photos, enter the machine system or even record on optical discs to see their pictures. They only have to start the computer, and can selectively retrieve and display the data stored in the digital storage device through the Basic Input/Output System. Hence users can directly start the machine to process without going through the operating system. The invention is more convenient in use.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A data display method for digital storage devices that connects a digital storage device to a computer executable platform to selectively display data of the digital storage device by adjusting settings of a Basic Input/Output System, comprising the steps of:
starting the Basic Input/Output System;
initializing the computer executable platform;
processing initialization operation of a display mode;
establishing an access mode for the data;
reading the data; and
displaying the data.

2. The data display method of claim 1, wherein the initializing the system further includes initializing a chipset.

3. The data display method of claim 1, wherein the initializing the system further includes setting access for a memory.

4. The data display method of claim 1, wherein the starting the Basic Input/Output System further includes waiting a selected period of time to receive signals of an input device.

5. The data display method of claim 4 further including initializing an operating system after the selected period of time of waiting has elapsed.

6. The data display method of claim 4, wherein the signals of input device are generated by depressing one or more keys.

7. The data display method of claim 4, wherein the signals of input device are used to control display conditions of the data.

8. The data display method of claim 4, wherein the signals of input device are used to execute an initialization process of an operating system.

9. The data display method of claim 1, wherein the reading the data further includes a data decoding process.
